(19) United States
(12) Patent Application Publication
(10) Pub. No.: US 2006/0053996 A1
(43) Pub. Date: Mar. 16, 2006

(54) Light duty, long axis portable cutter

(76) Inventors: Martin M. Sobel, Flemington, NJ (US); Shelly Sobel, Flemington, NJ (US)

Correspondence Address: Kenneth P. Glynn, Esq.;GlynnTech, Inc., 24 Mine Street, Flemington, NJ, 08822, US

(21) Appl. No.: 10/941,391

(22) Filed: Sep. 15, 2004

(51) Int. Cl. B26D 5/08

(52) U.S. Cl. 83/614

(57) ABSTRACT

A light duty, long axis portable cutter includes a base member having a flat top and an elongated recessed cutting channel and an elongated housing guide connected to base member with a gap between the base member and the elongated housing guide so as to position a sheet to be cut atop the base member and under the elongated housing guide. The elongated housing guide is parallel to the channel, and has at least one track component adapted to receive a corresponding track component of the main housing. The main housing is adapted to move along the elongated housing guide parallel to the channel. It has a handle and a knife holder adapted to receive and hold a cutting knife or blade.

### BACKGROUND OF THE INVENTION

1. Field of the Invention

The present invention relates to portable cutters that include a base member, a housing guide, a housing and a knife holder on the housing. The knife holder is adapted to receive and hold a box cutter knife (with handle and blade), wherein the box cutter knife is removable and blades are removable, replaceable, or interchangeable. The device may be a stand alone, with its own table structure, a stand alone for placements on a table, desk or other structure, or maybe one that is removably attached to a table, desk or other structure.

2. Information Disclosure Statement

The following patents are representative prior art references relating to cutters:

U.S. Pat. No. 6,134,999 relates to a trimming station for sheet like articles comprising a first conveyor assembly conveying sheet material in a first orientation having a first trimming section with vibrating trimming elements. Further, a sheet material reorienting section is provided for the sheet material. Reoriented sheet material articles are conveyed in a second orientation to a second conveyor assembly having a second trimming section with trimming elements.

U.S. Pat. No. 6,098,515 describes an improved rotary trimmer having a blade biasing member. The biasing member biases the blade in an inoperative position in which the blade is retracted inside a housing when not in use. A manual actuating means is used to overcome the bias provided by the biasing member and to move the blade into an operative position in which at least the cutting edge of the blade projects from the housing.

U.S. Pat. No. 5,996,459 describes paper cutter or trimming device that comprises a cutting board including measuring indicia, rail assembly, and a carriage assembly including a circular blade. The indicia are calibrated in a scale measured from a predetermined cut line. The rail assembly is mounted in a perpendicular relation to the measuring indicia for pivotal movement between operative and inoperative positions with respect to the cutting board. The carriage assembly is mounted for sliding movement on the rail assembly. The cutting board may include a positive stop, and the rail assembly may be biased against the at least one stop when the rail assembly moves to the operative position.

U.S. Pat. No. 5,819,618 describes a rotary paper trimmer for cutting sheet material and a method of using the trimmer. The rotary paper trimmer has a base, a pressure pad, and a blade holder assembly. The pressure pad has a guide rail and a gear track attached to its upper surface. A blade holder assembly has an outer shell slideably attached to the guide rail, a shaft rotatably attached to the shell, a circular blade attached to the shell and adjacent a lateral edge of the base, and a gear attached to the shaft. As the blade holder assembly is slid on the guide rail, the gear engages with the gear track and rotates the shaft and circular blade to cut sheet material inserted between the pressure pad and base.

U.S. Pat. No. 5,802,942 illustrates a paper trimmer that includes a base and a plate pivotally attached to the base. A carrier is slideably attached to the plate in an elongated slot. A blade assembly includes a blade secured to a blade holder. The blade assembly is received in a cavity formed in the carrier such that a cutting edge of the blade extends below the plate and is received within a channel formed in a cutting region of the base when the plate is disposed over the cutting region. A paper is cut by translation of the carrier along the slot of the plate.

U.S. Pat. No. 4,854,204 describes improvements in the life of cutting knife blades and the quality of shearing of thick multiple sheet and shingled paper products produced in a paper trimming system having two circular rotatable knives mounted to overlap at a shearing station through which the paper products are passed. Thin steel annular disc cutting blades with teeth about the outer circumference are significantly improved in life be eliminating the effects of blade warping and non-continuous mating contact with a bed knife cutting surface in an adjacent shearing relationship that is not broken by intervention of sheared paper or out of round knife surfaces or by deflection of the cutting blade away from mating surface contact by the pressure of thick or shingled paper products. Friction and wear is reduced by inclination of the cutting blade to prevent continuous rubbing against sheared paper edges. These problems are resolved by dishing and mounting the thin flexible annular disc cutting knife at a small angle away from perpendicular to the axes of rotation of the knives and by supporting its outer circumference to prevent deflection away from mating contact with the bed knife cutting surface. Thus, the cutting edges between the two rotary knives remain in continuous contact to produce clean cuts without raggedness in the presence of heavy loading form thick many paged paper products even when shingled to present a succession of step function increases of cutting loads.

Notwithstanding the prior art, the present invention is neither taught nor rendered obvious thereby.

### SUMMARY OF THE INVENTION

The present invention light duty, long axis portable cutter provides significant advantages over prior art paper and paperboard and other commercially available cutters. Among these advantages are:

In the present invention, easily replaceable blades or box cutter knifes are used as the cutting mechanism.

There is a blade to cutting channel relationship that eliminates the need for consumable cutting mat.

In some preferred embodiments, there is a high friction grip surface of the hold down handle that helps to hold the media in position while it is being cut.

In some preferred embodiments, there is an instant access thumb control of the blade length or penetration.

In some preferred embodiments, there is a unitized, self-supporting construction that allows for easy mounting to most tables and work benches. It also makes the cutter portable, as easy installation allows quick simple removal and re-installation on another table.

In some preferred embodiments, the edge of hold down plate helps to “eyeball” the path of cutting blade through media. A light shining upward through the slot can show the path of the cutting edge in translucent or transparent material.

The present invention cutter may be used to cut and trim paper, foam core, laminated paper, vinyl sheets, card board, fabrics, poster board, etc.

In some preferred embodiments, The present invention allows the operator to raise and lower the cutting beam via a foot pedal. In this scenario, the operator has both hands free for positioning of the media. This is very useful on long cutters (over 5 or 6 feet).

The nature of the construction allows the cutter to be fabricated in sections as knock down assemblies. This feature provides for cost saving with respect to shipping because the long cutters can be disassembled and easily shipped inexpensively. Aluminum is a preferred material of construction for the larger components.

The present invention light duty, long axis portable cutter includes: (a) a base member having a flat top and an elongated recessed cutting channel; (b) an elongated housing guide connected to the top of the base member with a gap between the base member and the elongated housing guide so as to position a sheet to be cut atop the base member and under the elongated housing guide, the elongated housing guide being parallel to the channel, the elongated housing guide having at least one track component selected from one of a male track component and a female track component, and adapted to receive the other of a male track component and a female track component of a main housing; (c) a main housing adapted to move along the elongated housing guide parallel to the channel, the main housing having a handle, having at least one track component selected from one of a male track component and a female track component moveably connected to the housing guide, and having a knife holder adapted to receive and hold a cutting knife.

In preferred embodiments, the present invention light duty, long axis portable cutter elongated housing guide is connected to the top of the base member indirectly, by connection to one or two guide support members that are connected to the top of the base member. The elongated housing guide, or beam, is preferably supported by two guide support members at opposite ends of the elongated housing guide. While this is preferred, a single guide support member may be used with a cantilevered elongated housing guide.

In some preferred embodiments, the present invention light duty, long axis portable cutter base member has two opposing sections and the channel is established by a void between the two opposing sections.

In some preferred embodiments, the present invention light duty, long axis portable cutter two opposing sections have horizontal plates with downwardly extending vertical plates with the channel therebetween.

In some preferred embodiments, the present invention light duty, long axis portable cutter elongated guide and the main housing each have at least two of the track components and the track components of the elongated guide are complementary to the track components of the main housing.

In some preferred embodiments, the present invention light duty, long axis portable cutter base member includes a paper cutter table.

In some preferred embodiments, the present invention light duty, long axis portable cutter base member includes attachment means for portable, removable attachment to a table.

In some preferred embodiments, the present invention light duty, long axis portable cutter attachment means is at least one clamp.

In some preferred embodiments, the present invention light duty, long axis portable cutter main housing includes an inverted U-shaped portion moveably nested about the elongated housing guide.

In some preferred embodiments, the present invention light duty, long axis portable cutter knife holder includes a knife slider controller for adjustment of knife blade height.

In some preferred embodiments, the present invention light duty, long axis portable cutter knife holder includes a plurality of ratchet slots for movement and locking of the knife slider controller within the plurality of ratchet slots for adjustment of knife blade height, and the cutter includes a knife with breakaway segments.

In some preferred embodiments, the present invention light duty, long axis portable cutter elongated housing guide is vertically moveable within the guide support member to provide elongated housing guide height adjustment capability.

In some preferred embodiments, the present invention light duty, long axis portable cutter guide support member includes a vertical guide and a manual vertical adjustment controller for vertically raising and lowering the elongated housing guide.

In some preferred embodiments, the present invention light duty, long axis portable cutter vertical adjustment controller is a manually rotatable screw and lock and the elongated housing guide is threaded and functionally connected to the manually rotatable screw and lock.

In some preferred embodiments, the present invention light duty, long axis portable cutter elongated guide and the main housing each have at least two of the track components and the track components of the elongated guide are complementary to the track components of the main housing.

In some preferred embodiments, the present invention light duty, long axis portable cutter main housing includes an inverted U-shaped portion moveably nested about the elongated housing guide.

In some preferred embodiments, the present invention light duty, long axis portable cutter knife holder includes a knife slider controller for adjustment of knife blade height.

In some preferred embodiments, the present invention light duty, long axis portable cutter knife holder includes a plurality of ratchet slots for movement and locking of the knife slider controller within the plurality of ratchet slots for adjustment of knife blade height, and the cutter includes a knife with breakaway segments.

In some preferred embodiments, the present invention light duty, long axis portable cutter channel is less than 15 inches in length.

In some preferred embodiments, the present invention light duty, long axis portable cutter channel is at least 15 inches in length.

### BRIEF DESCRIPTION OF THE DRAWINGS

The present invention should be more fully understood when the specification herein is taken in conjunction with the drawings appended hereto wherein:

FIG. 1 shows an oblique front view and FIG. 2 shows a top oblique view of one embodiment of a present invention portable cutter;

FIG. 3 shows a partial blown up view of the present invention portable cutter shown in FIGS. 1 and 2 and FIG. 4 shows an end view thereof;

FIG. 5 shows an end view of the FIG. 4 present invention portable cutter, but in the raised position and mounted to a bench top with a clamp;

FIG. 6 is a perspective-view of another embodiment present invention portable cutter with a foot operated system for raising and lowering the elongated housing guide and main housing;

FIG. 7 shows a partial oblique view of another present invention portable cutter, illustrating a guide support member spring;

FIG. 8 shows a partial, cut oblique view of another embodiment of a present invention portable cutter that is a foot operated version utilizing a linkage system instead of a cable system;

FIG. 9 shows a fully mounted version of a present invention device that is partially shown in FIG. 7;

FIG. 10 shows a fully mounted version of a present invention device that is partially shown in FIG. 6;

FIG. 11 illustrates a table-end mounted alternative embodiment present invention portable cutter and FIG. 12 shows an exploded view thereof;

FIG. 13 and FIG. 14 illustrate partial cut exposed views of the right end and left end respectively of the present invention device shown in FIG. 11 and FIG. 12.

### DETAILED DESCRIPTION OF THE PRESENT INVENTION

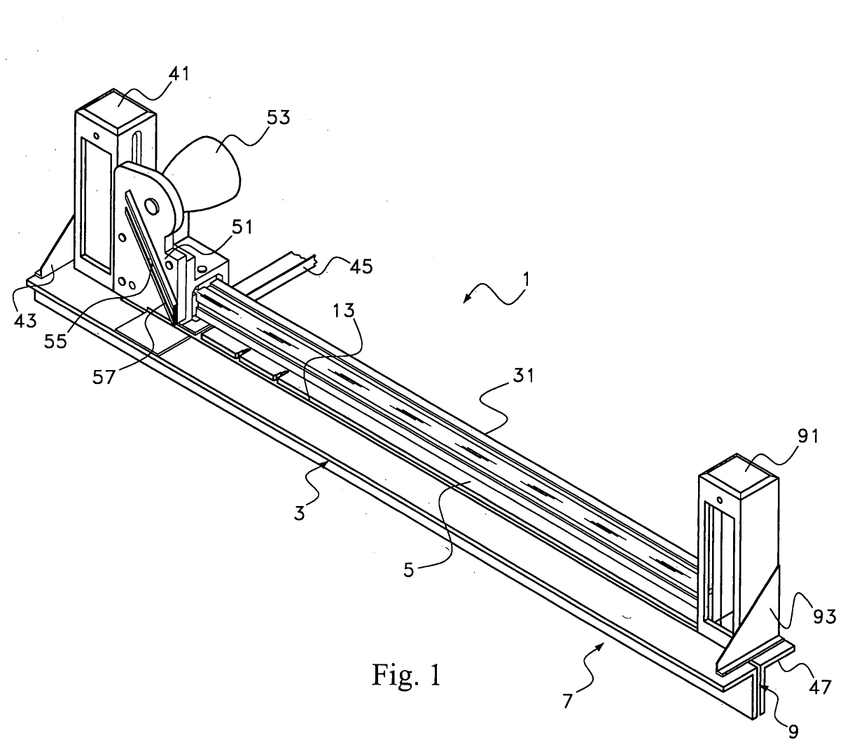

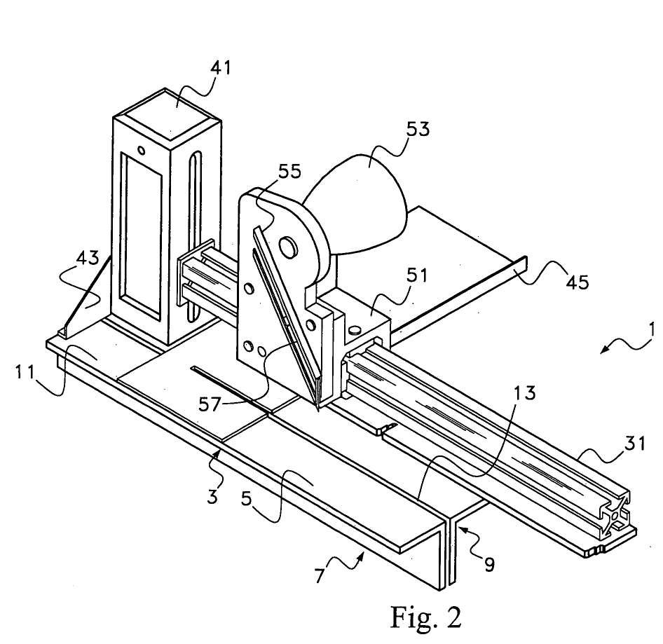

FIG. 1 shows an oblique front view and FIG. 2 shows a exploded view of a present invention portable cutter 400. It includes a base member 3 having a flat top 5. In this embodiment, the base member 3 is formed of two sections, namely, base member section 7 and base member section 9, discussed in further detail below. There is an attachment plate 11, in this embodiment, that aids to maintain the positioning of base member section 7 and base member section 9 so as to establish a recess 13 for cutting blade travel.

Elongated housing guide 31 is connected to the top of base member 3 indirectly via guide support member 41 and guide support member 91, at opposite ends. In other words, guide support members 41 and 91 are screwed, bolted, welded, riveted, slot-fitted or otherwise attached to base member 3. Right angle brackets 43 and 93 aid to eliminate vibration and torquing.

Elongated housing guide 31 is moveably connected to guide support member 41 and guide support member 91 in this embodiment, although elongated housing guide 31 could include an L-shaped piece or a cantilevered bridge attached directly to base member 3, or it could be attached to one or more supports such as guide support members in a non-moveable manner wherein only the blade height is adjustable. However, in this preferred embodiment, the elongated housing guide 31 is vertically adjustable via a lock/unlock ratchet mechanism engaged between elongated housing guide 31 and guide support members 41 and 91 to provide height adjustment. In FIG. 1, elongated housing guide 31 has been lowered to a cutting position, and in FIG. 2, it has been raised to a non-cutting position to permit thick stock insertion or any insertion desired prior to cutting, especially difficult-to-cut long axis work pieces.

Slideably attached to elongated housing guide 31 is a main housing 51, in this case, with an end view having an inverted U portion. Main housing 51 is able to slide from left to right, and vice versa, for cuffing and return. It has a convenient handle 53 and has a knife holder 55, adapted to receive and hold a cutting knife or cutting knife blade 57.

As can be seen, elongated housing guide 31 is positioned parallel to recessed cutting channel 13 and appropriately positioned and aligned so that a cutting blade such as blade 57 may move back and forth within recessed cutting channel 13. To facilitate the positioning of work pieces to be cut, in this embodiment, there is an optional, but preferred, work piece guide rail 45 and an extended work piece support 47 attached to cutter 1, as shown.

In this embodiment, the guide is initially held in the up position by springs attached to the beam at each end and shown in more detail below. The operator places the material to be cut under the raised guide 31. Using line of sight the user may align the material with the edge of and an extended work piece support 47 or the blade recess to establish the cut line. As a result of the downward force imposed be the operator on handle 53 the force of the springs is overcome and the guide 31 moves down to rest on top of the material to be cut, clamping it between the horizontal surfaces of base support member 9 and high friction surface 5. This clamping action and/or the fence 45, prevent the material from being moved be the forces imposed by the cutter blade, when pushed through the material. The operator then pushes down on the handle 53 and pushes the housing and blade 57 along the appropriate length of the beam so as to cut the material.

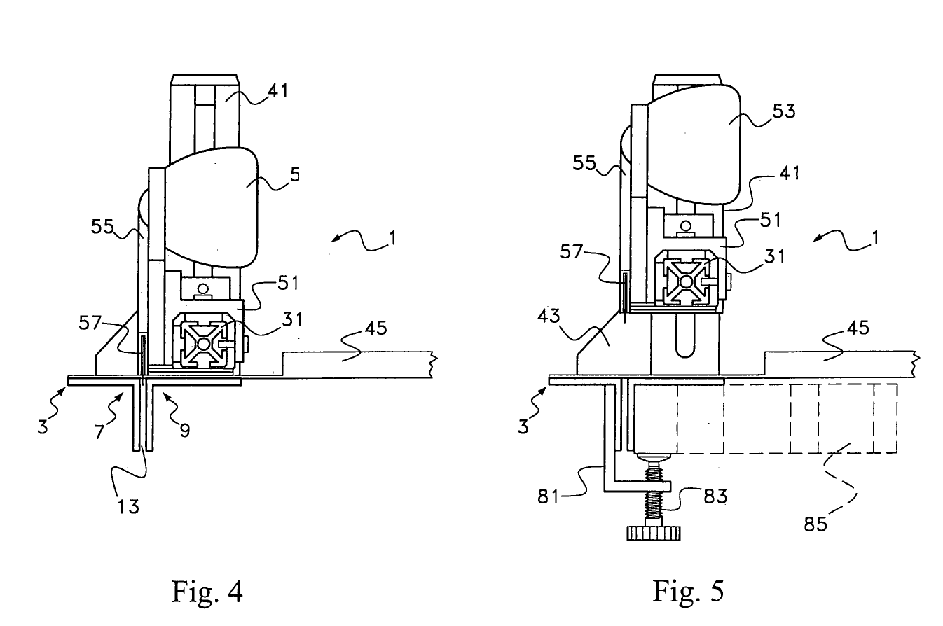

Present invention portable cutter 1, as shown in FIGS. 1 and 2, may have an overall effective cutting length to accommodate short axis and long axis cutting of rectangular stock thus, it may have a 12 inch cutting run (capable of cutting the long axis of an 8 inch by 11½ inch work paper or other work piece, or 20 inch to accommodate stock up to that width, or 36 inch, 48 inch, 60 inch, 72 inch or other effective widths, as may be desired). Further, it may be placed between the ends of two tables, it may be bolted or otherwise attached, or it may be temporarily fixed (see, for example, FIG. 5 below). Alternatively, it may be attached to its own stand, such as a table saw or the like. In yet other embodiments, it may be permanently attached to a small table top (cutting block) made of wood, plastic, or other material. This could have a X-axis and a Y-axis scale in inches, centimeters or both and it could have a cross-hatched topography as is common with smaller “chop block” paper cutters.

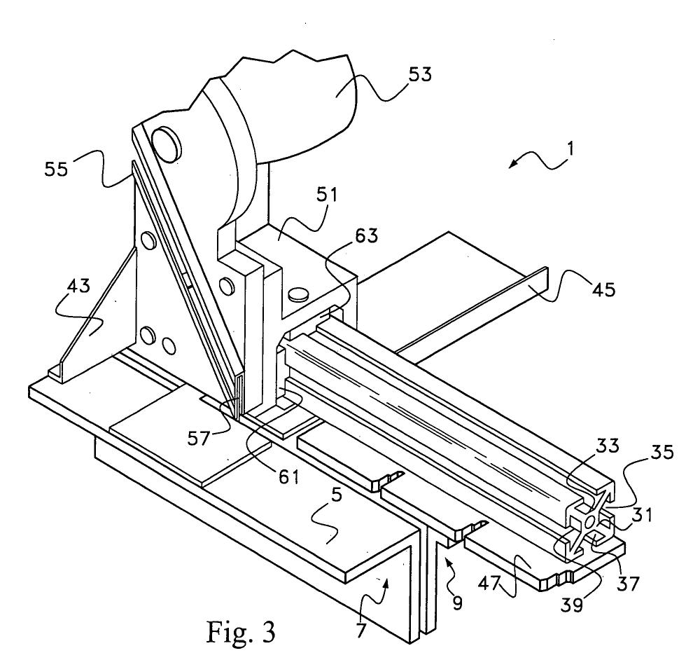

FIG. 3 shows a partial blown up view of the present invention portable cutter shown in FIGS. 1 and 2, and FIG. 4 shows an end view thereof. These two Figures are now described together, and identical parts are identically numbered and follow the same numbering as in FIGS. 2 and 3 above. Here it can more clearly be seen that base member section 7 and base member section 9 are adjacent right angle sections with recessed cutting channel 13 located therebetween. Further, elongated housing guide 31 has four parallel female track components 33, 35, 37, and 39, three of which are being used in this embodiment. Specifically, main housing 51 has three corresponding male components, two of which are shown as components 61 and 63. These slide horizontally along the corresponding female track component, as shown; 5 any number of tracks may be used as desired.

In FIG. 5, present invention portable cutter 1 is shown in an end view, with elongated housing guide 31 raised, and with parts identical to those described above being identically numbered. Additionally, there is a clamp 81 with a locking screw 83 welded or bolted to the underside of base member 3 as shown in FIG. 5. Locking screw 83 has been tightened against bench top 85 to secure present invention portable cutter 1 without the need for permanent attachment fixtures. Thus, although it is attached to the bench top 85, it is easily removed. Additionally, major components of present invention portable cutter 1 may be assembled to one another with hex screws or other fasteners to permit fabrication in sections as knock down assemblies to provide for compact shipping and storage when not in use. Thus, the nature of the construction allows the cutter to be fabricated in sections as knock down assemblies. This feature provides for cost saving with respect to shipping because the long cutters can be disassembled and shipped via package courier, as opposed to trucking.

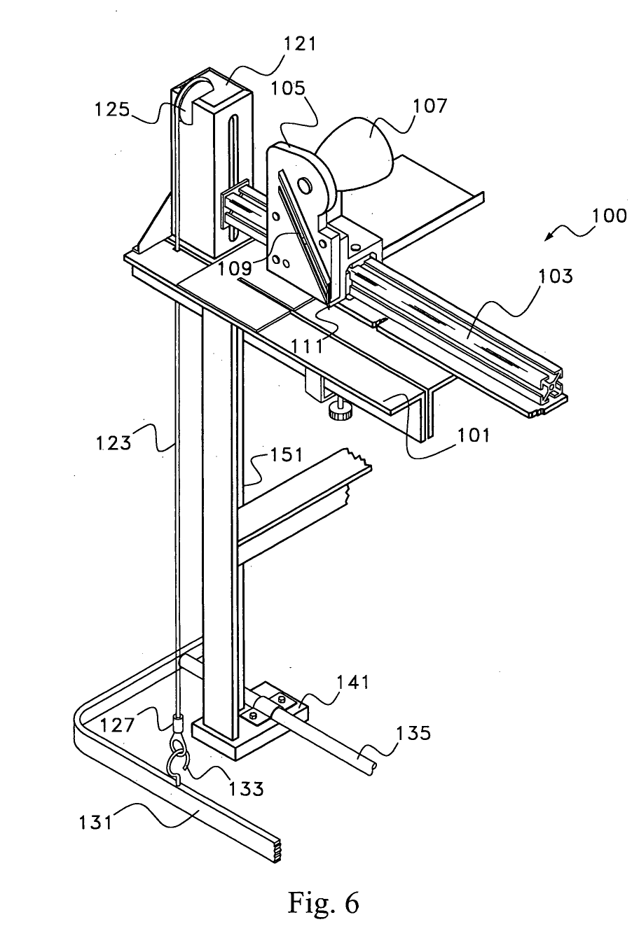

FIG. 6 shows an alternative embodiment present invention light duty, long axis portable cutter 100. It includes a base member 101, an elongated housing guide 103, a main housing 105 with handle 107, a knife holder 109 and a knife blade 111, which all function similarly to the similar component described in conjunction with the Figure. Other components unnumbered, as well as details unnumbered of the numbered components that are shown in the above Figures and in this Figure likewise operate similarly. Guide support member 121, in this embodiment, (as well as its opposite end counterpart, not shown) operates via a foot pedal for raising and lowering elongated housing guide 103. Thus, a cable 123 is connected at its top end to an internal portion of elongated housing guide 103, directly, via a lever or any other mechanical mechanism. Cable 123 passes over a pulley 125 and is connected at its lower end to foot pedal 131. Bottom end 127 of cable 123 is connected to an attachment means 133 of foot pedal 131. Foot pedal axle 135 rotates about a fixed horizontal axis. Block assembly 141 is positioned under bench leg 151 and holds axle 135 in place. The weight of elongated housing guide 103 and its other components is heavier than the foot pedal 131 and biases elongated housing guide 103 downwardly and foot pedal 131 upwardly. When foot pedal 131 is pressed by a user, elongated housing guide 103 is raised. By raising and lowering a portion of the foot that rests against foot pedal 131, a user will be able to control the raising, lowering and cutting positioning of elongated housing guide 103 and main housing 105 so that both hands are free to move or position the work piece and slide main housing 105 for accurate, efficient cutting operation.

In the foot operated configuration shown in FIG. 6, as well as below, the Guide is initially held in the down position by springs and/or it's own weight. The operator steps on the foot pedal to raise the guide and places the workers piece to be cut under the guide. He then allows the guide to come to rest on the material by removing his foot. It is at this time that he can modulate the clamping force of the guide by gently applying foot pressure to the pedal. This allows the operator to precisely move and position the material (using both hands) with respect to the blade recess and/or the edge of the fence. The operator then pushes down on the handle (this provides additional clamping pressure) and pushes the housing and blade along the appropriate length of the guide so as to cut the material.

This feature is very useful when handling long pieces of material on long cutters, (over 5 or 6 feet). In addition, it facilitates very accurate line up with reference marks on the material such as cut lines and crop marks.

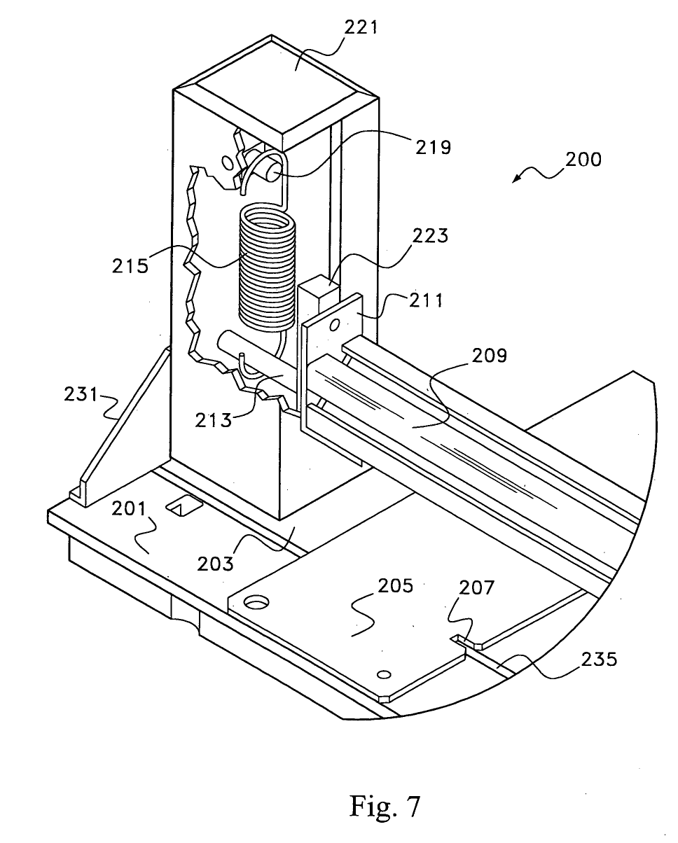

FIG. 7 shows a partial oblique view of another present invention portable cutter 200, illustrating a guide support member spring mechanism. Present invention portable cutter 200 includes a base member section 201 and a base member section 203 with a flat top and with a recess 235 therebetween. Joinder plate 205 maintains the positioning of base member section 201 and base member section 203 and is aligned at cutout 207 with recess 235. The main housing guide 209 is similar to main housing guide 51 described above, with similar arrangements and slideable main housing (not shown) attached thereto. Left end 211 of main housing guide 209 is connected via rod 213 to guide support member 221 through vertical portal 223. A spring 215 is connected to rod 213 at its bottom and fixedly attached to rod 219 and the top of guide support member 221. Support bracket 231 stabilizes guide support member 221 and eliminates vibration upon up-and-down movement of main housing guide 209. A mirror image setup is located at opposite end, not shown.

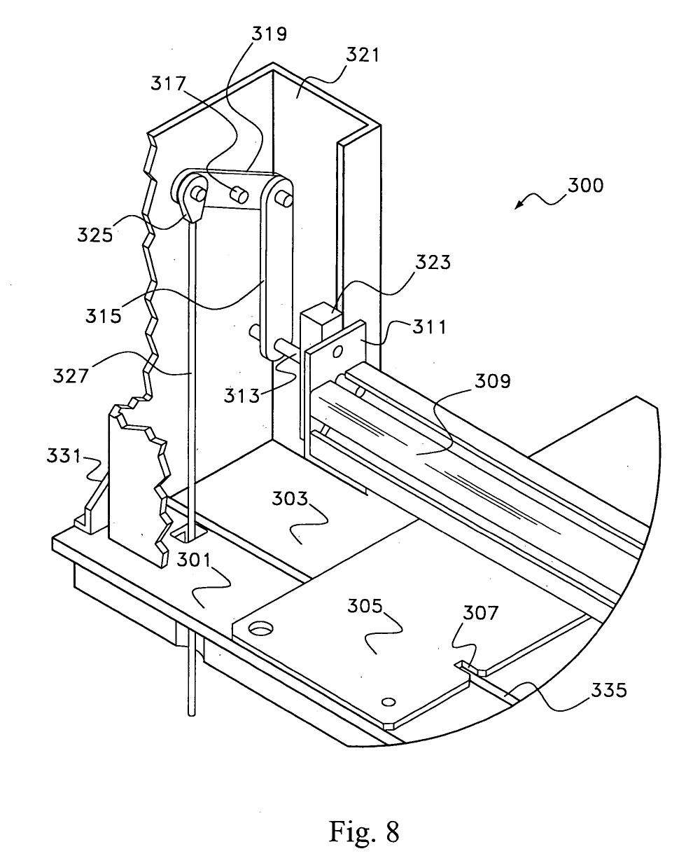

FIG. 8 shows a partial, cut oblique view of another embodiment of a present invention portable cutter 300 that is a foot operated version utilizing a linkage system instead of a cable system. Present invention portable cutter 300 includes a base member section 301 and a base member section 303 with a flat top and with a recess 325 located between them. Joinder plate 305 maintains the positioning of base member section 301 and base member section 303 and is aligned at cutout 307 with recess 335. The main housing guide 309 is similar to main housing guide 51 described above with similar arrangements and slideable main housing (not shown) attached thereto. Left end 311 of main housing guide 309 is connected via rod 313 to guide support member 321 through vertical portal 323. A link rod 315 is connected to rod 313 at its bottom and attached to rocker arm 319 at the top. Rocker arm 319 pivots on pin 317, and is also connected to tie rod 327 via connector 325, as shown. This, in turn connects to a foot pedal (not shown. There is an opposite end set up (not shown). Depression of the pedal lifts the guide 309 through these linkages. Support bracket 331 stabilizes guide support member 321 and eliminates vibration upon up-and-down movement of main housing guide 309.

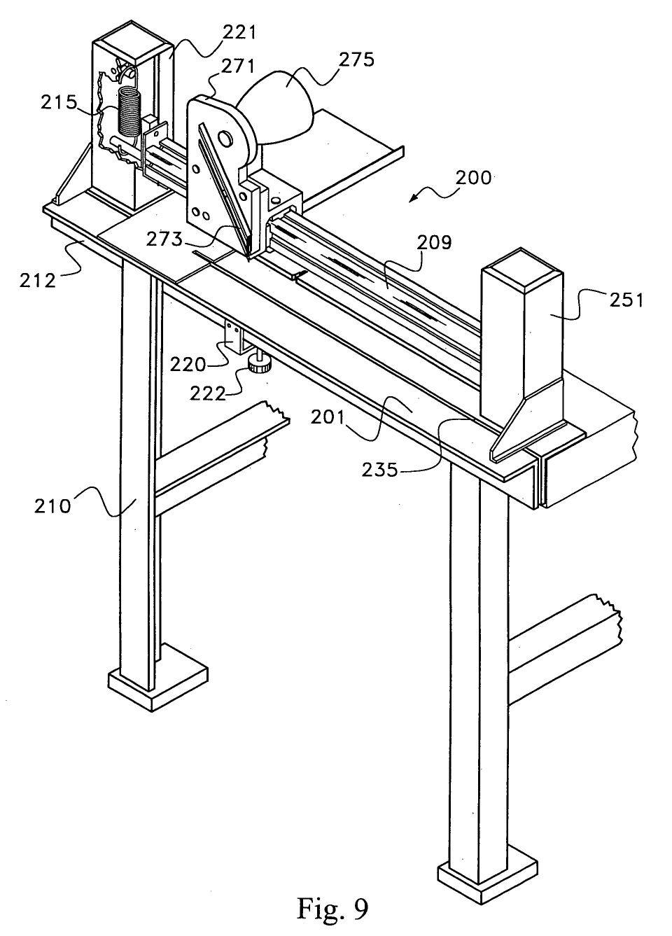

FIG. 9 shows a fully mounted version of a present invention cutter device 200 that is partially shown in FIG. 7. Identical parts are identically numbered and need not be repeated. Cutter device 200 is attached to table 210 by a clamp 220 with adjustable height lock 222. Vertical plate 212 of base member section 201, in this embodiment, has clamp 220 permanently attached thereto. Main housing 271 includes a blade holder 273 and an ergonomic handle 275. Main housing guide 209 is connected at its left with guide support member 221 and at its right with guide support member 251.

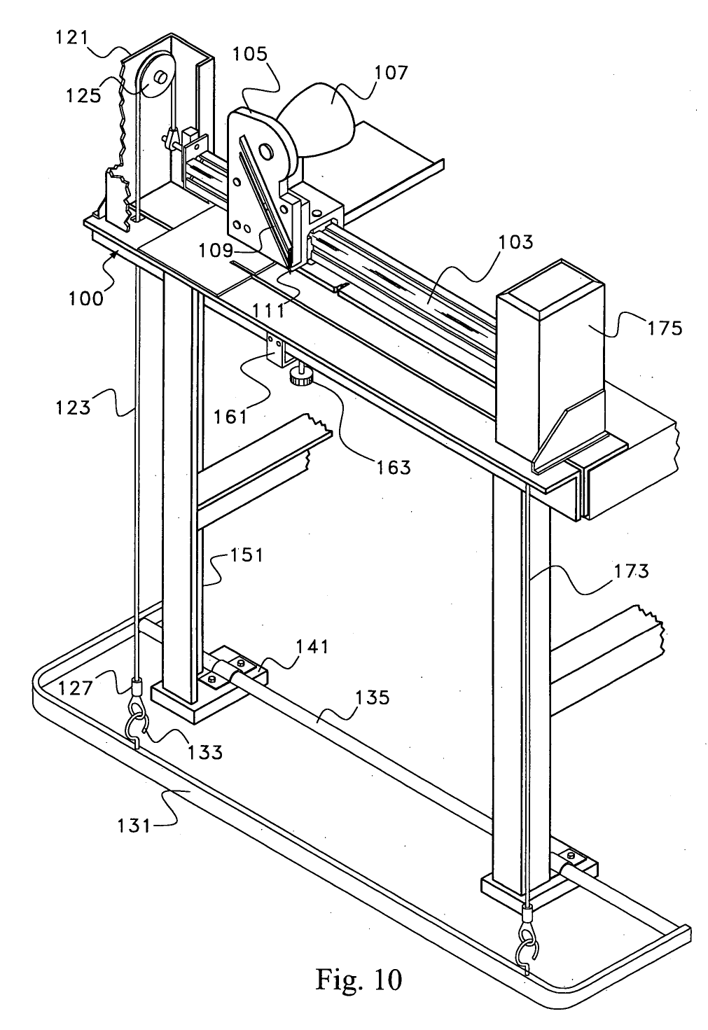

FIG. 10 shows a fully mounted version of a present invention cutter device 100 that is partially shown in FIG. 6. Cutter device 100 includes identical parts shown in FIG. 6 with identical numbers. However, clamp 161 is shown to be tightened by a knob 163 to bottom of table 151. Also, right side guide support member 175 is shown with cable 173 operating parallel with cable 123, both being attached to foot pedal 131.

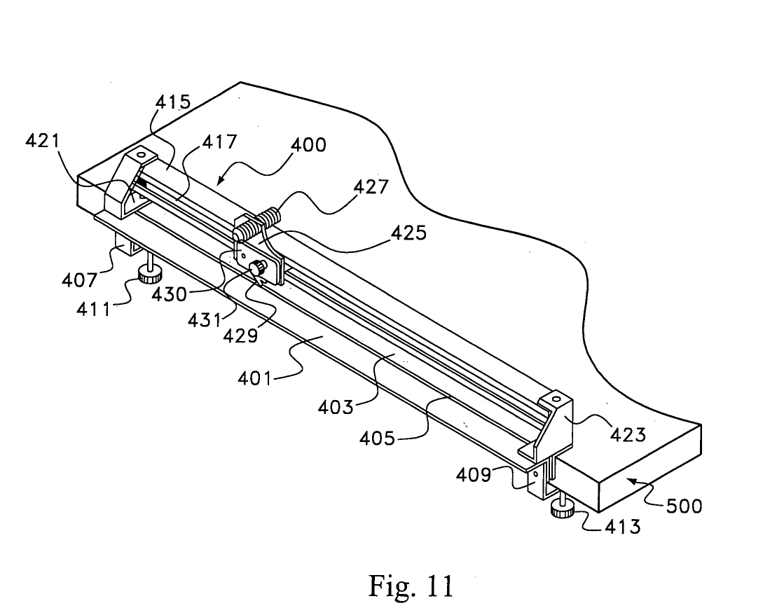

FIG. 11 shows an oblique front view and FIG. 12 shows an exploded view of a present invention portable cutter 400. It includes a base member formed of two sections, namely, base member section 401, and base member section 403. There are two opposing end guide support members 421 and 423 that aid to maintain the positioning of base member section 401 and base member section 403 so as to establish a recess 405 for cutting blade travel.

Elongated housing guide 431 is connected to the top of the base member sections 401 and 403 indirectly via guide support member 421 and guide support member 423. In other words, the guide support members 421 and 423 are screwed, bolted, welded, riveted, slot-fitted or otherwise attached to base member sections 401 and 403, and also aid to eliminate vibration and torquing.

There is an elongated housing guide 410 that is a rotated “U” channel with a top plate 415 and a bottom plate 417. This elongated housing guide 410 is moveably connected to guide support member 421 (with cover 426) and guide support member 423 with pins and springs (described below).

Slideably attached to elongated housing guide 410 is a main housing 425, in this case, with an end view having an a generally “L” shape. Main housing 425 is able to slide from left to right, and vice versa, for cutting and return, as its tongue fits into elongated housing guide 410. It has a convenient handle 427 and has a knife blade holder 430 with lightening screw 431, adapted to receive and hold a cutting knife blade or a razor blade 429.

As can be seen, elongated housing guide 425 is positioned parallel to recessed cutting channel 405 and appropriately positioned and aligned so that a cutting blade such as razor blade 429 may move back and forth within recessed cutting channel 405.

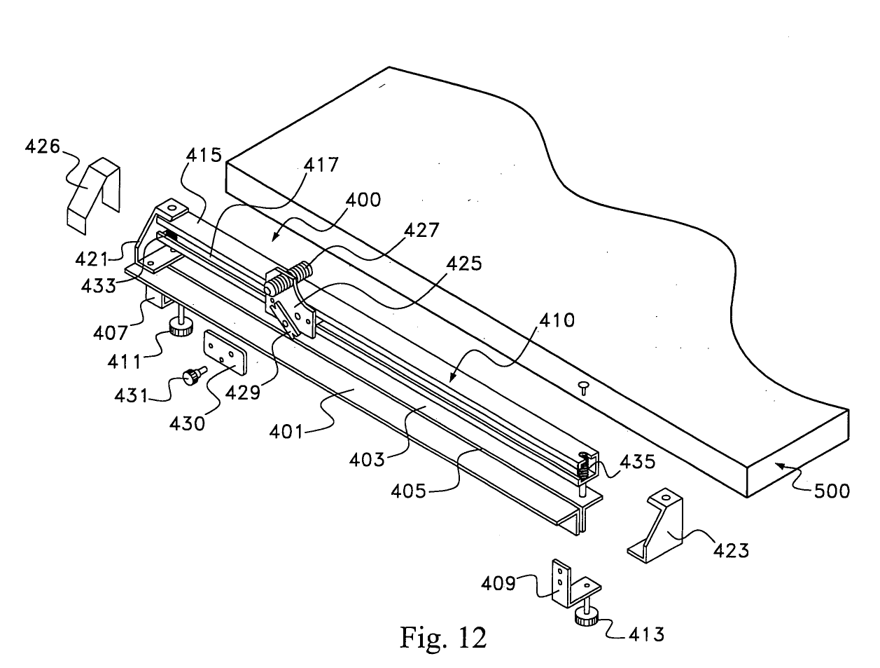

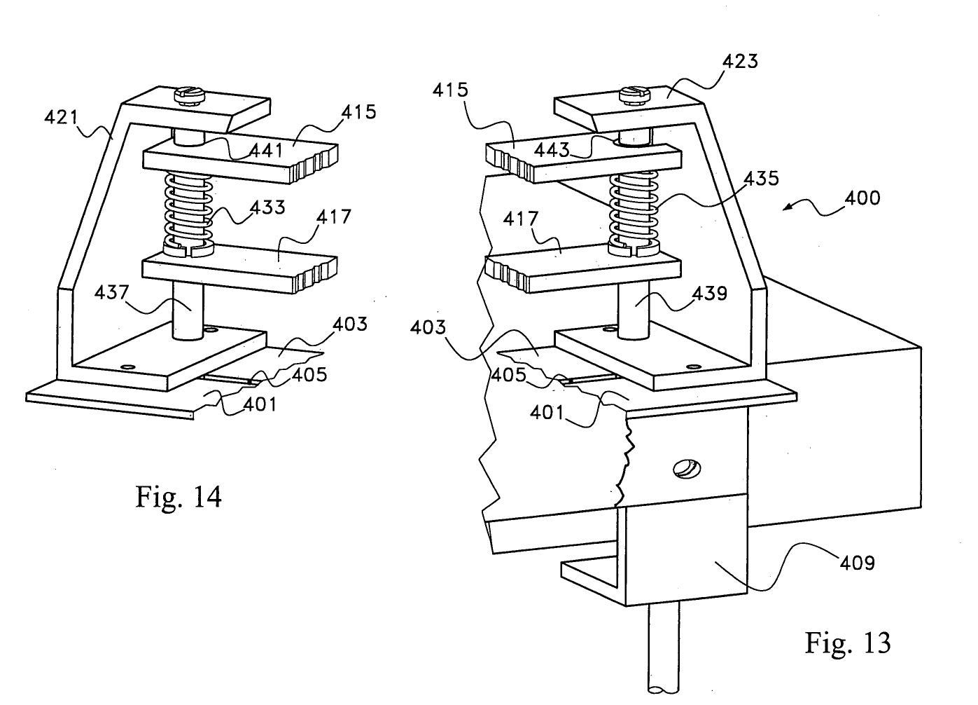

Referring now to FIGS. 11, 12, 13, and 14, wherein all identical parts are identically numbered, FIGS. 13 and 14 specifically show details of a new type of lower/raise arrangement for the cutter. In this embodiment, the guide is initially held in the up position by springs 433 and 435 attached to the elongated housing guide 410 at each end and shown in more detail in FIGS. 13 and 14. The guide 410 rides on posts 437 and 439. The operator places the material to be cut under the raised guide 410. Using line of sight the user may align the material as desired with the portion to be cut at the blade recess 405 to establish the cut line. As a result of the downward force imposed be the operator on handle 427, the force of the springs is overcome and the guide 410 moves down to rest on top of the guide support members 421 and 423. The operator then holds the handle 427 down and pushes the housing 425 and blade 29 along the appropriate length of the beam so as to cut the material.

Note that in this preferred embodiment (FIGS. 13 and 14), the left side of elongated housing guide 410 is connected to pin 437 via two holes (e.g. hole 441), while the right side has one cut out 443. This gives elongated housing guide 410 some balance shift-tilt room to avoid torquing and pinching or jerking down and allows easy self-adjustment and horizontal stabilization when pushed down by a user.

Obviously, numerous modifications and variations of the present invention are possible in light of the above teachings. It is therefore understood that within the scope of the appended claims, the invention may be practiced otherwise than as specifically described herein.

What is claimed is:

1. A light duty, long axis portable cutter, which comprises:
(a) a base member having a flat top and an elongated recessed cutting channel;
(b) an elongated housing guide connected to said top of said base member with a gap between said base member and said elongated housing guide so as to position a sheet to be cut atop said base member and under said elongated housing guide, said elongated housing guide being parallel to said channel, said elongated housing guide having at least one track component selected from one of a male track component and a female track component, and adapted to receive the other of a male track component and a female track component of a main housing;
(c) a main housing adapted to move along said elongated housing guide parallel to said channel, said main housing having a handle, having at least one track component selected from one of a male track component and a female track component moveably connected to said housing guide, and having a knife holder adapted to receive and hold a cutting knife.

2. A light duty, long axis portable cutter of claim 1 wherein said base member has two opposing sections and said channel is established by a void between said two opposing sections.

3. A light duty, long axis portable cutter of claim 2 wherein said two opposing sections have horizontal plates with downwardly extending vertical plates with said channel therebetween.

4. A light duty, long axis portable cutter of claim 1 wherein said elongated guide and said main housing each have at least two of said track components and said track components of said elongated guide are complementary to said track components of said main housing.

5. A light duty, long axis portable cutter of claim 1 wherein said base member includes a paper cutter table.

6. A light duty, long axis portable cutter of claim 1 wherein said base member includes attachment means for portable, removable attachment to a table.

7. A light duty, long axis portable cutter of claim 6 wherein said attachment means is at least one clamp.

8. A light duty, long axis portable cutter of claim 1 wherein said main housing includes an inverted U-shaped portion moveably nested about said elongated housing guide.

9. A light duty, long axis portable cutter of claim 1 wherein said knife holder includes a knife slider controller for adjustment of knife blade height.

10. A light duty, long axis portable cutter of claim 9 wherein said knife holder includes a plurality of ratchet slots for movement and locking of said knife slider controller within said plurality of ratchet slots for adjustment of knife blade height, and said cutter includes a knife with breakaway segments.

11. A light duty, long axis portable cutter of claim 1 wherein said elongated housing guide is connected to said top of said base member indirectly, by connection to guide support member that is connected to said top of said base member.

12. A light duty, long axis portable cutter of claim 11 wherein said elongated housing guide is vertically moveable within said guide support member to provide elongated housing guide height adjustment capability.

13. A light duty, long axis portable cutter of claim 12 wherein said guide support member includes a vertical guide and a manual vertical adjustment controller for vertically raising and lowering said elongated housing guide.

14. A light duty, long axis portable cutter of claim 13 wherein said vertical adjustment controller is a manually rotatable screw and lock and said elongated housing guide is threaded and functionally connected to said manually rotatable screw and lock.

15. A light duty, long axis portable cutter of claim 13 wherein said elongated guide and said main housing each have at least two of said track components and said track components of said elongated guide are complementary to said track components of said main housing.

16. A light duty, long axis portable cutter of claim 13 wherein said main housing includes an inverted U-shaped portion moveably nested about said elongated housing guide.

17. A light duty, long axis portable cutter of claim 13 wherein said knife holder includes a knife slider controller for adjustment of knife blade height.

18. A light duty, long axis portable cutter of claim 17 wherein said knife holder includes a plurality of ratchet slots for movement and locking of said knife slider controller within said plurality of ratchet slots for adjustment of knife blade height, and said cutter includes a knife with breakaway segments.

19. A light duty, long axis portable cutter of claim 1 wherein said channel is less than 15 inches in length.

20. A light duty, long axis portable cutter of claim 1 wherein said channel is at least 15 inches in length.
